(19) United States
(12) Patent Application Publication
(10) Pub. No.: US 2011/0177742 A1
(43) Pub. Date: Jul. 21, 2011

(54) FUNCTIONAL SHEET

(76) Inventors: Filip Frederix, Heverlee (BE); Dionislus Maria Joseph Gilissen, Eljsden (NL); Marko Dorschu, Beek (NL); Alexander Antonius Marie Stroeks, Valkenburg aan de Geul (NL)

(21) Appl. No.: 13/003,456

(22) PCT Filed: Jul. 9, 2009
(86) PCT No.: PCT/EP09/58749

§ 371 Date: Apr. 7, 2011

(30) Foreign Application Priority Data
Jul. 9, 2008 (EP) 08160019.9

(51) Int. Cl. C08F 110/02

(52) U.S. Cl. 442/370; 521/143

(57) ABSTRACT

The invention is directed to a functional sheet, to a method for preparing said sheet, to a packaging material and to the use of said packaging material. The functional sheet of the invention comprises a porous polymeric carrier having a porosity of at least 60%, preferably at least 80%, more preferably at least 90%, wherein said polymeric carrier comprises one or more functional compounds, which functional compound provides said sheet with at least one function selected from sensing, scavenging and releasing and wherein the polymeric carrier comprises one or more polyolefins and the average pore size of the polymeric carrier is at least 0.11 μm.

### FUNCTIONAL SHEET

The invention is directed to a functional sheet, to a method for preparing said sheet, to a packaging material and to the use of said packaging material.

Functional sheets are very useful, for instance when applied in packaging material for products such as food and/or pharmaceuticals. Functions that are particularly advantageous are sensing, scavenging, adsorbing, absorbing, change of colour and/or releasing.

For instance, a food packaging can comprise a functional sheet having a sensing property and is capable of sensing specific compounds that are indicative of deterioration of food, such as biogenic amines, H₂S, hydroxyacids, ketoacids and aldehydes. Preferably, the sensing function of the functional sheet is visibly detectable. The functional sheet can for instance change colour when compounds that are indicative of food deterioration are generated. Consumers can thus be warned and can recognise spoiled food without even having to open the packaging.

In a similar fashion, a scavenging function is also highly advantageous. For example, it may be highly desirable to have a packaging material that is able to scavenge oxygen from within the package in order to reduce oxidation of the packed product. Also the scavenging of water can be very advantageous. In particular, when the packaged product is susceptible to oxidation or if water may have a detrimental effect to the product, such a scavenging packaging material may increase the lifetime of the product in the package. In the example of a food or a pharmaceutical, oxygen scavenging can reduce food oxidation, and thereby postpone or slow down food deterioration. Also the scavenging of water from a food or a pharmaceutical packaging concept can be highly desirable for example to protect the quality of the packaged product.

Another functional property which may be advantageously applied in a sheet is the release of one or more specific compounds. As an example, it can be highly advantageous to have a packaging material that releases a biocide in order to protect a product, such as a food product or a pharmaceutical, in order to protect the product from biological infestation and growth. Depending on the application there are numerous other examples of beneficial compounds to be released by a functional sheet.

A common problem to the above identified functional sheets is that all these functional sheets should be able to carry out their functionality relatively quickly. Thus, for example in the case of a sensing function, the sensing compound should quickly detect a specific change in its surroundings and show a detectable response. In the case of a scavenging function, it is often advantageous that specific molecules are scavenged from the environment quickly. An example is formed by oxygen sensitive food products packed under MAP (modified atmosphere packaging) conditions. Just before closing the package by e.g. a seal step, the package including the food is flushed with an inert gas like N₂ or CO₂. In practise, approximately 1-2% of oxygen remains in the package due to the compromise between an acceptable speed of the packaging line and residual oxygen. It is beneficial however to remove these traces of oxygen by an oxygen scavenger that reacts relatively fast with the remaining oxygen. For conventional oxygen scavengers, introduced in the non-porous packaging material, it may take days before the oxygen concentration comes to a value <0.1% in the package. This is regarded as long and there is a drive to reduce this particular time scale. Similarly, a quick release of specific compounds from a functional sheet can be very advantageous, in particular when the compounds are released in response to another specific disadvantageous compound.

However, the prior art teaches functional sheets in which the functional compounds are not readily accessible or not readily releasable from a matrix. Often such accessibility or such a release concept is governed by slow diffusion into or out of the matrix in which the functional compound is present.

The materials applied for a functional sheet to a large extent determine the sheet's final properties, including the response time of the compound to changes in its environment. At the same time, the choice of materials should not adversely affect other beneficial properties of the functional sheet, such as the strength and the thickness of dense substrate films, and also the pore size, the Gurley value and the strength properties of porous carrier films used as substrates. When the functional sheet is applied in a packaging material, the choice of materials should further not adversely affect advantageous properties of the packed product, such as the colour, shelf-life, quality, taste, etc. of the packed product.

In the prior art there have been made some attempts in order to provide functional sheets.

For instance, WO-A-2007/114514 describes an indicator which uniformly changes its colour and can be used to indicate a remaining validity time of for instance a bug-proof repellent. The indicator comprises a colour-changing layer (A) comprising a porous film having a liquid compound retained in the pores, and a substrate layer (B) having a property for preventing the diffusion of the liquid compound from the colour-changing layer (A) to the layer (B), wherein layers (A) and (B) are laminated with an adhesive layer (D). The porous film comprises a polyolefin resin containing at least 10% by weight of polyolefin having a molecular chain length of at least 2 850 nm. However the response time of the indicator in WO-A-2007/114514 is very long, the shortest response time mentioned is 26 days. Such long response times are not suitable to all applications such as for example in food applications.

WO-A-96/40412 describes oxygen-scavenging compositions comprising an oxidisable metal component, an electrolyte component and a solid non-electrolytic acidifying component. In the presence of moisture, the combination of the electrolyte and the acidifying component is said to promote reactivity of metal with oxygen. The oxygen-scavenging compositions can be incorporated in thermoplastic resins. This publication is silent with respect to the porosity of the resin.

WO-A-97/22469 describes polymeric compositions containing oxygen scavenging compositions. The oxygen scavenging composition is composed of a polymeric matrix having an ascorbate compound and a substantially water-insoluble, organic compound of a transition metal distributed within the matrix. The composition is said to be capable of providing good oxygen absorption capabilities while not adversely affecting the colour, taste or smell of material packages within a container having said composition as a part thereof.

U.S. Pat. No. 5,766,473 describes a porous polymeric material provided with a thin hydrophilic shell of poly(vinyl) alcohol, without altering the physical configuration of the porous structure.

Object of the invention is to provide a functional sheet having a quick response time to specific changes in its environment.

Further object of the invention is to provide a sheet with a sensing function, which sheet demonstrates a quickly detectable response to a specific change in its environment.

Yet another object of the invention is to provide a sheet with a scavenging function, in particular the scavenging of gaseous oxygen and/or water in a relatively fast way.

A further object of the invention is to provide a sheet with a release function, preferably the release of a specific compound in response to a specific change of the environment of the sheet.

Another object of the invention is to provide a packaging material which is able to sense and indicate a change in the condition of the packed product, for example deterioration, scavenge oxygen and or water from the packed product, and/or release compounds beneficial to the packed product.

The inventors found that one or more of the above objects are met by a functional sheet comprising a highly porous polymeric carrier which carrier comprises a functional compound.

In a first aspect, the invention is therefore directed to a functional sheet comprising a porous polymeric carrier having a porosity of at least 60%, preferably at least 80%, more preferably at least 90%, wherein said polymeric carrier comprises one or more functional compounds, which functional compound provides said sheet with at least one function selected from sensing, scavenging and releasing and wherein the polymeric carrier comprises one or more polyolefins and the average pore size of the polymeric carrier is at least 0.11 μm.

The term “sheet” as used in this application is meant to refer to any elongated laminar product of large surface area and relatively small thickness. Preferably, the thickness of the sheet is at least 10 μm, more preferably at least 25 μm, and most preferably at least 50 μm. The thickness of the sheet will normally be 1 mm or less, preferably 500 μm or less, more preferably 200 μm or less, most preferably 100 μm or less. At the start a sheet can have a higher thickness that however can be reduced by techniques well-known to the man skilled in the art. Examples of those techniques are calendaring or stretching. The thickness mentioned here refers to the thickness after that these optional techniques are applied, thus to the thickness of the sheet as it will be used.

The functional sheet of the invention comprises a polymeric carrier having a high porosity and an adequate average pore size which provides a high potential mobility of molecules in the carrier. By virtue of this high porosity and high potential mobility of molecules the functional compounds are readily accessible. This results in a surprisingly fast response time of the functional compounds to triggers from the environment, in particular to gaseous compounds in the environment which can easily diffuse into the porous carrier.

The polymeric carrier can be hydrophilic and hydrophobic, however the polymeric carrier is preferably hydrophobic. The polymeric carrier is preferably impermeable to liquid water, but permeable to water in gaseous state. The polymeric carrier can be a polymeric membrane, but also a woven or non-woven; the polymeric carrier being a non-woven is preferred. Non-limiting examples of polymeric materials that can be comprised in the polymeric carrier of the present invention are polyolefins (such as for example polyethylene, polypropylene, and ethylene-propylene copolymers), polyamides, polyesters, polyvinylalcoholes, polyurethanes, polyacrylates, polymethacrylates, fluoropolymers, polyethersulphones, polysulphones, polyvinylidenefluorides, polytetrafluoroethylenes, polycarbonates, polyolefins with hydrophilic groups, and mixtures thereof). Both homopolymers and copolymers are suitable, as well as polymer blends. Preferred polymeric carriers are polyolefins, in particular poly-α-olefins, such as for example polyethylene and polypropylene.

In an advantageous embodiment, the polymeric carrier comprises a high molecular weight, preferably an ultrahigh molecular weight (UHMW) polyolefin, such as for example UHMW polyethylene and/or UHMW polypropylene. Even more preferred is a mixture of UHMW polyolefin and high molecular weight (HMW) polyolefin, since such a mixture provides a larger average pore size as compared to UHMW polyolefin alone. A suitable mixture is for instance a mixture of highly stretched polyolefin, such as highly stretched UHMW polyethylene and HMW polyethylene. In the context of this application UHMW polyolefin (such as UHMW polyethylene) is defined as a polyolefin having a M_{w} in the range of 1 000 000-10 000 000 g/mol. In the context of this application HMW polyolefin (such as HMW polyethylene) is defined as a polyolefin having a M_{w} in the range of 250 000-750 000 g/mol. The weight average molecular weight of polyethylene is determined with the aid of the known methods such as Gel Permeation Chromatography and Light Diffusion or is calculated from the Intrinsic Viscosity (IV), determined in decalin at 135° C. A weight average molecular weight of, for example 0.5×10⁶ g/mol corresponds to an IV, determined in decalin at 135° C., of 5.1 dl/g according to the empirical equation

M_{w}=5.37×10⁴[IV]^{1.37}

The polymeric carrier can be stretched in order to provide the carrier with a sufficiently open structure and high porosity. The man skilled in the art is familiar with the various stretching techniques, additionally reference is made to for example EP-0.504.954 and EP-0.500.173. Before stretching the porosity is typically very low, such as 30-40%, and the pores are typically very small. In addition, stretching yields increased mechanical properties, such as a high strength, because the polyethylene chains are more and more aligned in the plane of the membrane. Preferably, the polymeric carrier is stretched biaxially. A membrane based on UHMW polyethylene has as advantage that thin micro-porous membranes with high porosity can be made. Particularly, a high content of UHMW polyethylene is advantageous as UHMW polyethylene may be processed by extrusion, using a hydrocarbon solvent. After drying, the extruded tape is stretched to form a very strong and affordable membrane as well as a membrane that is both chemically and mechanically stable (e.g. with regard to thermal cycling). Examples of useful membranes include those with polyalkenes comprising about 20 wt. % UHMW polyethylene or more. Preferably the membrane comprises 20 wt. % UHMW polyethylene or more. If high temperature resistant membranes are required, it may be advantageous to use membranes with about 40 wt. % UHMW polyethylene or more. Preferably the membrane comprises 40 wt. % UHMW polyethylene or more. Suitable grades exist with for example about 25 wt. %, about 30 wt. %, about 40 wt. %, the remainder of the material preferably being another polyolefin, such as HDPE (high density polyethylene), LLDPE (linear low density polyethylene), LDPE (low density polyethylene), PP (polypropylene) and the like. Preferably, mixtures of HDPE and UHMW polyethylene are used. A preferred polyolefin based polymeric carrier comprises 20-40 wt. % of UHMW polyethylene, 20-40 wt. % high density (HD) polyethylene and 30-50 wt. % low density (LD) polyethylene.

In a preferred embodiment, the polymeric carrier is a hydrophobic membrane preferably comprising UHMW polyethylene as self-supporting membrane.

In a particularly advantageous embodiment the polymeric carrier comprises UHMW polyethylene part with a weight average molecular weight of about 1 000 000-10 000 000 g/mol as measured by via the intrinsic viscosity. The lower limit corresponds to the required (lower) tensile strength of the membrane whereas the upper limit corresponds to an approximate limit where the material becomes too rigid to process easily. The UHMW polyethylene may be bi-modular or a multimodular mixture, as that increases processability.

Typically, a biaxially stretched UHMW polyethylene film forming a polymeric carrier for use in the functional sheet according to the invention provides a tensile strength in the machine direction of about 7 MPa or higher, preferably about 10 MPa or higher. In case a very high strength is required, the membrane is calendared to realise a tensile strength of about 40 MPa, or 60 MPa or higher. The high strength allows for much thinner membranes and/or membranes that do not require supporting rigid grids during use. Furthermore, the elongation at break for such polyethylene membranes is typically in the order of 30% in the machine direction. This allows for a substantial deformation during use without deteriorating the performance of the membrane.

The polymeric carrier can have a thickness of 10 μm to 150 μm, preferably of 15 μm to 50 μm. A thinner membrane has the advantage of potentially higher flux.

The polymeric carrier has a porosity of at least 60%. Polymeric carriers with even higher porosities such as at least 80% or at least 90%, are even more preferred. The porosity of the polymeric carrier is defined as the percentage of the volume of all the pores in the polymeric carrier with respect to the whole volume of the polymeric carrier.

The porosity values as mentioned in this application are calculated using the following equation:

Porosity(%)={1−{BW/(thickness×ρ)}}×100%

wherein BW=base weight of the film (g/m²), thickness is expressed in μm, ρ=density expressed in g/cm³.

The high porosity of the polymeric carrier provides for a mobile environment, in which compounds can quickly penetrate and from which compounds can quickly escape. The high porosity of the carrier thereby to a great extent determines the quick response time of the functional molecules contained within the polymeric carrier. The mechanical strength of the polymeric carrier suffers from very high porosities of the polymeric carrier. Therefore, in practice the porosity of the polymeric carrier does not normally exceed porosities of 98%, preferably the porosity of the polymeric carrier is 95% or less.

The average pore size of the polymeric carrier can suitably be in the range of 0.01-10 μm, preferably the average pore size is at least 0.11 μm, more preferably at least 0.2 μm, most preferably at least 0.15 μm. The average pore size is generally equal to or less than 10 μm, preferably equal to or less than 5 μm, more preferably equal to or less than 2 μm. The average pore size of the polymeric carrier lies preferably in the range of 0.11-10 μm, preferably in the range 0.12-5 μm, more preferably in the range 0.15-2 μm. The average pore size is measured with a Coulter porometer.

By virtue of the high porosity of the polymeric carrier there is also a large surface area available for potential functional guest compounds to adhere. Hence, the polymeric carrier can be loaded to a high loading degree with functional compounds. This is, for instance, of particular advantage in the case where the functional compound provides for the scavenging or release function, because a higher loading degree of functional molecules will automatically lead to a higher level of scavenging or release. Also in the case of a sensing function, high loading degrees of functional compounds can be beneficial, especially when the optical response of the functional compounds is rather weak and/or when the change to be sensed is rather small.

Without wishing to be bound by theory, the inventors believe that also the specific surface area of the polymer carrier (which can be coated with functional compounds) is very important with respect to accessibility. Filling the membrane with too much functional compound can reduce the accessibility of for instance oxygen or water too much. Preferably, there is a balance between surface area and porosity.

As the preferred polymeric carrier is hydrophobic, it is impermeable to liquid water. This can be particularly advantageous when water has a disadvantageous effect on the functional compound within the polymeric carrier. In addition, because the polymeric carrier is hydrophobic, it is prevented that the functional compound easily escapes the polymeric carrier using water as a solvent

If desired, the hydrophobic polymeric carrier can be rendered hydrophilic. This can be done e.g. by chemical grafting of hydrophilic groups (such as acrylic acids), or by mixing polyolefin with polyolefin oxides, such as polyethylene with polyethyleneoxide.

In a preferred embodiment, the polymeric carrier comprises the material commercially available under the trademark Solupor® by Lydall-Solutech B.V. Solupor® is a non-woven membrane, having a layered structure. Solupor® is produced by extrusion of a solvent together with a solution comprising a mixture of UHMW and HMW polyethylene, followed by drying the resulting tape and biaxial stretching of the tape, resulting in a microporous membrane. This process is described in more detail in EP-0.504.954 which is hereby incorporated by reference. A layered non-woven membrane allows for the sensing materials to be stored in the membrane, with the option for the sensing materials to react with chemicals that are for instance released by packed products in a package. The Solupor® material comprises UHMW polyethylene, and a portion of lower molecular weight polyethylene. The material is biaxially stretched and has a porosity that can be varied between 45-95%. Depending on the needs, the porosity of the Solupor® can be adjusted by controlling the preparation parameters, such as the stretching factor to increase porosity and calendaring to reduce porosity. The man skilled in the art knows what techniques are available to control the porosity and he can easily determine which technique is most suitable for the situation. In addition, EP-0.504.954 describes some of those techniques. Solupor® is commercially available in a range of porosities. The average chain length of the UHMW polyethylene in Solupor® is about 0.7 mm (C—C distance in polyethylene is about 1.4×10⁻¹⁰ and typical number of ethylene molecules is 5×10⁶).

The polymeric carrier preferably has a very open fibrous structure, wherein the fibres provide mechanical strength to the sheet, while the voids between the fibres provide the polymeric carrier with the high porosity. The polymeric carrier preferably has a Gurley value (gas permeability) of 50-250 s/50 ml.

The one or more compounds that provide the sheet with the sensing, scavenging and/or release function can be adhered (such as physisorbed or chemisorbed) to the polymeric carrier. Alternatively, one or more of the compounds can be covalently attached to the polymeric carrier. It is also possible that part of the compounds is adhered, while another part is covalently attached. The functional compounds can also be solved in the polymeric material or be present as a separate phase in the polymer material. Covalently attached compounds have the advantage of being fixed so that they cannot easily escape the polymeric carrier. However, in some cases, such as when the compounds itself are to be released from the polymeric carrier, it may be advantageous to have the one or more compounds adhered to the carrier. The functional compound, that is the compound that provides the functional sheet with the sensing, scavenging and/or releasing function, is incorporated in the polymeric carrier during its preparation process. The polymeric carrier can be prepared according to the preparation process as described in EP-0.504.954.

In an embodiment at least one of the one or more compounds that provide the sheet with the respective function is hydrophilic. Preferably, more than one of the compounds is hydrophilic, and more preferably all of the functional compounds are hydrophilic. Although the porous polymeric carrier is preferably hydrophobic, the hydrophilic functional compound can be introduced into the polymeric carrier by solving the one or more hydrophilic compounds in an alcohol and subsequently impregnating said porous carrier with the alcoholic solution of the hydrophilic compounds.

A wide range of functional compounds can be used for the invention, as long as they provide the sheet with one or more functions selected from sensing, scavenging and releasing.

Since the molecules to be sensed or scavenged will have to diffuse to and contact the respective sensing or scavenging compounds, it is advantageous when the sensing and/or scavenging compounds are easily accessible in the polymeric carrier. Similarly, molecules or compounds to be released will have to diffuse to a site where they can be useful. To a large extent, this required mobility is accomplished by the high porosity of the carrier combined in a certain degree with the average pore size. This is in contrast with packaging materials where the functional compound is integrated in the polymer packaging material. In this latter case, the diffusion of the to be sensed and/or scavenged compounds through the polymer material determines to a considerable extent the response time of the total system. By making use of the described porous carrier material, this diffusion time related to diffusion through a polymer material can be significantly reduced in case the sensing and/or scavenging compounds are present in the polymer carrier material or reduced to zero in case the sensing and/or scavenging compounds are available at the surface of the carrier material.

In an embodiment, the functional sheet is provided with a sensing function. In the context of this application a sensing function is meant to refer to the ability to sense a specific change in the environment. It is preferred that a change in the environment, once sensed, results in a detectable response of the compound. It is also possible that the sensing function involves the sensing of more than one change in the environment.

In order to determine whether a sensing compound has a response to a change in its environment, the response of the sensing compound can be detectable. A preferred form of detection is optical detection. The sensing compound can for instance give a response involving a colour change, luminescence, luminescence quenching, and/or a change in luminescence lifetime. A very advantageous form of detection is by vision of the human eye, because it does not require additional instruments. In an embodiment, therefore, a sensing molecule undergoes a visible colour change upon a specific change in its environment. The colour change does not necessarily have to involve a transfer from one colour to another colour, but can for instance also involve the disappearance or appearance of a colour.

Preferred changes in the environment to be sensed include changes in pH and changes in the concentration of one or more specific compounds, preferably gaseous compounds (typically such compounds include polar or non-polar molecules). Examples of preferred compounds to be sensed are e.g. a change in the humidity (in particular an increase of the H₂O concentration), a change in amine concentration (in particular an increase in biogenic amine concentration which may e.g. be indicative for food deterioration), a change in oxygen concentration (in particular an increase of the oxygen concentration which may cause oxidation of a packed product).

Examples of materials suitable to act as sensing material are luminescent materials (such as fluorescent and phosphorescent materials) and colour indicating materials. Luminescent materials absorb light in a certain region of the spectrum and emit light in another region of the spectrum. The presence of a gas, such as oxygen or carbon dioxide, can quench the light emitted by the luminescent material. Therefore emitted light that reaches a suitable detector can be used to determine the concentration of the gas present inside the package. Fluorescent materials are preferred. Examples of fluorescent materials are ruthenium (Ru) complex, osmium (Os) complex, platinum (Pt) complex, Iridium (Ir) complex, Rhenium (Re) complex, Rhodium (Rh) complex, polycyclic aromatic hydrocarbons, metalloporphyrines, (C₆₀ or C₇₀)-fullerene, or a combination of any of them. Examples of polycyclic aromatic hydrocarbons are pyrene, 1-pyrene decanoic acid, 1-pyrene dodecanoic acid perfluorodecanoic acid or 1-decyl-4-(1-pyrenyl)butanoate. Examples of metalloporphyrines are (Pt²⁺, Pd²⁺, or Zn²⁺) metalloporphyrines. Preferred fluorescent materials are chosen from the list (Ru)-complex, (Pt)-complex, (Pd)-complex or a combination of any of them. More preferred fluorescent materials are tris(4,7-diphenyl-1,10-phenanthroline)ruthenium(II) dichloride, tris(2,2′-bipyridyl)ruthenium(II), tris(1,10-phenanthroline)ruthenium(II) dichloride, platinum(II)-octaethylporphine ketone, platinum(II)-tetraphenylporphyrin, paladium(II)-tetraphenylporphyrin and combinations of any of them.

The fluorescent light can be detected by commercially available apparatus, such as for example O2xySense™ fluorescence apparatus of OxySense®, Dallas, USA.

Colour indicating materials suitable to act as sensing compound are materials that change their colour upon interaction with the relevant gas for which the sensor is used. Examples of suitable colour indicating materials are carotene, methylene blue, phenol red, bromocresolgreen, ascorbic acid, 2,6-dichloroindophenol, methyl violet, basic blue-3, phenosafranine, capri blue, lauth violet, methylene green, neutral red, safranine-T, indigo carmine or a combination of any of them.

In an embodiment, the functional sheet is provided with a scavenging function. In the context of this application a scavenging function is meant to refer to the ability to scavenge one or more specific molecules.

A scavenging function may be particularly advantageous when the functional sheet is comprised in a packaging material for packing products that can deteriorate in the presence of specific detrimental molecules. The scavenging compounds in the functional sheet can, for instance, scavenge the specific detrimental molecules such as for example water, oxygen, NH₃ or other amines, ethanol, propanol, and/or butanol. Preferably the functional sheet according to the invention contains a functional compound that has a water and/or oxygen scavenging function.

With respect to oxygen scavenging compounds, one can distinguish between oxygen scavenging compounds of an inorganic or organic nature. Non-limiting examples of inorganic oxygen scavenging compounds are the non-noble metals and metal salts in which the metal can change its valence state. Non-limiting examples are iron, aluminium, copper, zinc and their salts. Auxiliary compounds might be added with the purpose to increase the intrinsic oxidation speed of the metal or metal salts. Well-known substances to increase the oxidation speed are salts such as sodium chloride, calcium chloride and sodium hydro-pyrophosphate.

Non-limiting examples of organic oxygen scavenging compounds are polymer compounds based on unsaturated addition polymers, such as polybutadiene or polyisoprene undergoing an allylic oxidation process. A second category is based on polymers containing polyalkylene oxide units, such as polyethyleneoxide, polytetrahydrofuran but with a preference for propyleneoxide. Propyleneoxide is most susceptible for proton abstraction, the first step in the oxidation process, and consequently can be oxidized rather easily. Preferably, the polyalkylene oxide unit with a typical number average molar mass of 1 000-5 000 g/mol, might be part of a multiblock copolymer consisting of e.g. polyester or polyamide blocks. A third category is based on polymer materials consisting of the meta-xylylene diamine (MXD) functionality. An example is the semi-aromatic polyamide MXD6, a well-known barrier polyamide material that is rather easily oxidised.

Besides these oxygen scavenging functional groups, auxiliary compounds might be added to further increase the oxidation speed. Examples are oxidation catalysts with non-limiting examples transition metal catalysts that can readily switch between at least two oxidation states. Preferably, the transition metal is in the form of a transition salt or transition metal complex. Suitable metals include cobalt, chromium, manganese, nickel or rhodium.

Water scavenging or desiccant compounds which can be used in the composition, include, but are not limited to, desiccants that obtain their moisture absorbing capabilities through physical absorption. Examples of these physical absorption desiccants include molecular sieves, calcium carbonate, silica gels and clays, such as the naturally occurring clay compounds, like for example montmorillonite clay. Desiccant materials can also have a polymeric nature, like polyacrylic acid, polyvinylalcohol, polyethyleneoxide and polyacrylamide, their copolymers and cross-linked version of these polymers.

In an embodiment, the functional sheet is provided with a releasing function. In the context of this application a releasing function is meant to refer to the ability to release one or more specific molecules. For example, this release may be a response to a specific trigger, such as the presence or absence of a specific molecule, or some change in the environment of the functional sheet.

The molecules to be released may be the compound that provides the sheet with the releasing function itself. However, it is also possible that the compound providing the sheet with the releasing function releases one or more molecules, preferably in reaction to the presence of a specific molecule, such as water or oxygen, preferably water vapour. Molecules to be released depend on the application of the functional sheet. Particularly preferred compounds to be released in the case of a functional sheet comprised in a packaging material (such as for a food product, or a pharmaceutical) include biocides, preservatives, and ripening agents.

With respect to release functionality, examples are related to the release of components that influence the quality or the shelf life of the packed product in a positive manner. A non-limiting example is the release of ethylene gas, a ripening gas to be used for a variety of different kinds of fruits. Another example is related to the release of hydrogen peroxide, a component capable of interacting with microorganisms that negatively influence the quality of the packed product. Another example is related to the release of CO₂ that can be realised by the presence of carbonate salts or bicarbonate salts. These salts might be combined with acids, like citric acid, oxalic acid and fumaric acid.

The amount of the compound to be present in the functional sheet can vary depending on the needs. If necessary, the large available surface area created by the porous polymer carrier allows high loading degrees of the one or more compounds. Concentrations of the one or more compounds in the functional sheet can for instance vary from 0.001-0.4 g compound per g carrier. Typical amounts for sensing compounds range from 0.1-5 wt. % based on total weight. Typical amounts for scavenger compounds range from 2-40 wt. % based on total weight. Typical amounts for releasing compounds range from 2-40 wt. % based on total weight.

The functional sheet can be in the form of a laminate, having two or more layers, of which at least one layer is the porous polymeric carrier comprising the one or more compounds which provide the sheet with the sensing, scavenging and/or releasing function.

The laminate can further comprise a barrier layer, which acts as a barrier for liquid water. This is advantageous in order to prevent or at least reduce the escaping of the one or more functional compounds from the porous polymer carrier, in particular when the functional compound is not hydrophilic and/or bound to the polymeric carrier. It is preferred that the barrier layer is impermeable to liquid water. However, advantageously the barrier may be permeable to gases, such as water vapour or oxygen. The barrier layer may be provided on one side of the impregnated polymeric carrier, but it is also thinkable that the barrier layer is present on both sides of the impregnated polymeric carrier. It is preferred that the barrier layer is essentially free from compounds having a sensing, scavenging and/or releasing function.

Examples of suitable barrier layers include hydrophobic polymeric layers, such as layers of polyolefins (such as polyethylene, polypropylene, and ethylene-propylene copolymers), polyurethanes, polyacrylates, polymethacrylates, fluoropolymers, polyamides and polyesters. Both homopolymers and copolymers are suitable, as well as polymer blends. Preferred polymeric carriers are polyolefins, in particular poly-α-olefins, such as polyethylene and polypropylene.

In a specific embodiment, the functional sheet is in the form of a laminate comprising only two layers, one layer being the polymeric carrier having the one or more functional compounds, the second layer being a layer which acts as a barrier for liquid water. In case the one or more functional compound is a sensing compound that has a colour change as a response, it is advantageous that the barrier layer has a white colour. This gives a good contrast for visualising the colour change. The laminate comprising the functional sheet and the barrier layer can be used in a packaging material. In that case it can be advantageous to use the barrier layer on the side of the packaged product in order to prevent water from the product to reach the polymeric carrier loaded with the one or more functional compounds.

The functional sheet can be incorporated into a packaging concept in several ways. With packaging concept is meant the total of the combination of elements that are used to package a certain product. Such a packaging concept can for example be a bag in which a certain individual product or a collection of the same products or a collection of various products is packaged. A packaging concept can also for example be a tray covered with a wrapping film, such as for example used in packaging of meat products. The man skilled in the art of packaging will understand that all kinds of combinations of packaging materials are possible and are used in the industry. When the packaging concept contains more than one element the man skilled in the art will understand that the material out of which those elements are made are not necessarily the same; generally the separate elements will be made out of different materials so as to be able to fulfill the necessary requirements. For example the tray in the packaging concept with the wrapping film, will generally be made out of a different material than the wrapping film.

The functional sheet can be incorporated into a packaging concept in several ways. It can for example be incorporated in the form of a loose sheet, in the form of a sticker onto the inner side of the packaging concept, or in the form of a strip sealed into one of the elements of the packaging concept. In another embodiment a sealed sheet is introduced by laminating the functional sheet with a film or part of the film of the packaging concept. The film of the packaging concept may consists of the classical film materials with various functionalities, such as water and/or mechanical barrier, mechanical performance such as sufficient stiffness, puncture resistance, optical transparency, printability. The laminate may further comprise oxygen barrier and/or water barrier polymer materials, all depending on the desired functionality of the laminate.

The thickness of the sheet is not of particular relevance. However, in order to maintain the very good accessibility of the compounds in the polymeric carrier, the thickness of the sheet will normally be 1 mm or less, preferably 500 μm or less, more preferably 200 μm or less, most preferably 100 μm or less.

In a further aspect the invention is directed to a method for preparing a functional sheet as described herein, comprising preparing a porous hydrophobic polymeric carrier having a porosity of at least 60%, and impregnating said porous carrier with said one or more compounds by contacting said porous carrier with a solution of said one or more compounds in an alcohol.

The preparation of a porous polymeric carrier having a porosity of at least 60% is well known in the art. Solupor® may for instance be prepared by forming a solution of UHMW polyethylene into a base tape, and removing the solvent from the base tape. The resulting dry tapes can be stretched biaxially to create an open structure and increase the mechanical properties. The mixture of polymer and solvent is heated to form a polymer solution using an extruder. Upon cooling, the UHMW polyethylene and solvent are separated. The solvent can be removed e.g. by evaporation, resulting in a dry base tape with a micro-porous structure. The dry base tape can then be stretched, using a treatment in one or more directions. Stretching of the solvent-free film increases the film area, which in turn causes a reduction of the film thickness. For a further description reference is made to EP-0.504.954, which is herein incorporated by reference.

The inventors found that surprisingly the one or more functional compounds can be readily inserted into the polymeric carrier by solving the one or more compounds into an alcohol and subsequently impregnating the carrier with said solution, even when the one or more functional compounds comprise hydrophilic compounds. Suitable alcohols that can be used as a solvent for the one or more compounds include methanol, ethanol, propanol and butanol.

In a further aspect, the invention is directed to a packaging material comprising the functional sheet of the invention. Such packaging material may be in particular advantageous for packing products, such as food products, pharmaceuticals, chemicals, or electronic components.

In a further aspect, the invention is directed to the use of said packaging material for packing food and/or pharmaceutical products.

The invention will now be further illustrated by the following non-limiting examples.

### EXAMPLES

In the following examples a desiccant as functional compound is introduced into the polymeric carrier. Two types of desiccants were introduced during the gel process that is used to produce porous (U)HMWPE films.

### Desiccant 1

Superabsorbant polymer poly(acrylic acid) partial potassium salt; CAS number 25608-12-2 obtained from Sigma/Aldrich. Particle size of this PAA is 1000 micrometer.

### Desiccant 2

Molecular sieve with chemical composition Na₁₂[(AIO₂)₁₂(SiO₂)₁₂].×H₂O.; CAS number 70955-01-0 obtained from Sigma/Aldrich. Average particle size of this molsieve is 2.5 micrometer.

### Example 1

A 20 wt % solution of polyethylene in 80 wt % decaline was prepared. (The polyethylene consists of two DSM commercial grades UH210 and HM6720 on a 50/50 wt % basis). To this solution 2 wt % of desiccant 1 (PAA) was added under stirring conditions to prevent precipitation of the desiccant. This mixture was extruded with a co-rotating twin screw extruder 19 mm/25 D at a temperature of 180° C. The extruder head was fitted with a die with a rectangular gap with dimensions 120 mm*0.7 mm. The extruded film was introduced into a decalin cooling bath with a temperature of 40° C. The solvent of the film was removed in an oven at a temperature of 70° C. under conditions where the film was free; that is it has the possibility to shrink freely in all directions.

### Example 2

The procedure as described in Example 1 was repeated except for the drying conditions: in this Example 2 the drying was performed under fixed planar conditions: that is the film was not able to shrink in both planar directions.

### Example 3

The procedure as described in Example 2 was repeated. In addition, the film sample was simultaneously stretched in both planar directions at a stretching ratio 3*3 at 120° C.

### Example 4

Example 1 was repeated except for the introduction of the desiccant. Instead of introducing 2 wt % of desiccant 18 wt % of desiccant 2 was applied.

### Example 5

The procedure as described in Example 4 was repeated except for the drying conditions: in this example the drying was performed under fixed planar conditions: that is the film was not able to shrink in both planar directions.

### Example 6

The procedure as described in Example 5 was repeated. In addition the film sample was simultaneously stretched in both planar directions at a stretching ratio 3*3 at 120° C.

The permeability to air was determined as the Gurley number (in s/50 ml) according to ASTM standard D726-58, using a measuring area of 6.45 cm² and a weight of 567 grams. This Gurley number is a measure for the porosity of the films.

In the following table, the Gurley numbers are presented for the films as described in Examples 1-6. These Gurley numbers clearly indicate that films that are able to shrink freely during drying (Examples 1 and 4) lead to non-porous films. Furthermore, one can conclude from these Gurley numbers that films, dried under mechanically fixed conditions (Example 2 and 5) lead to porous films and that the porosity increases when these films are biaxially stretched (Examples 3 and 6).

| Film of Example | Gurley number (s/50 ml) |
|---|---|
| 1 | ∞ |
| 2 | 152.8 |
| 3 | 6.8 |
| 4 | ∞ |
| 5 | 78.4 |
| 6 | 1.68 |

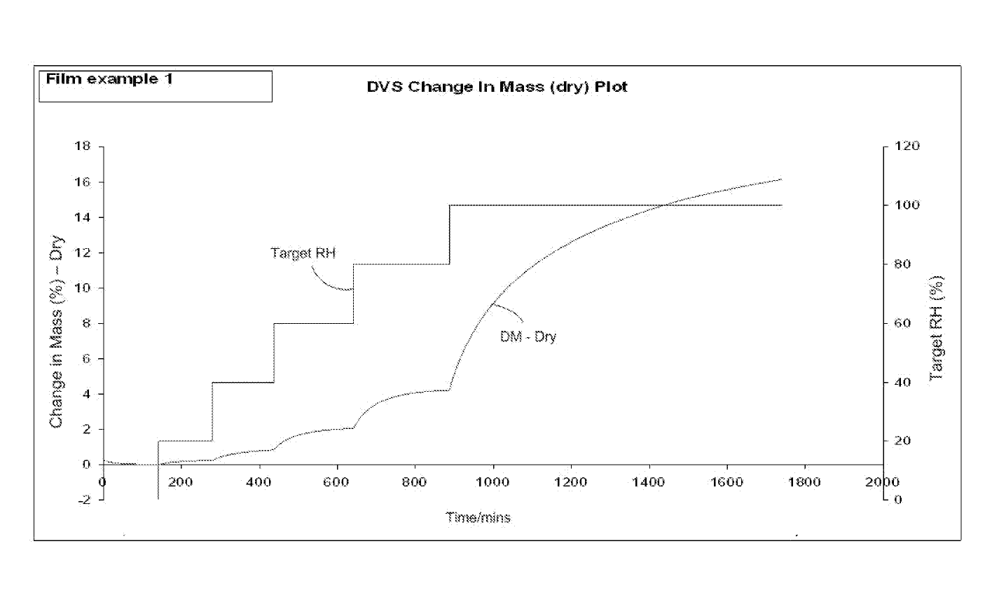

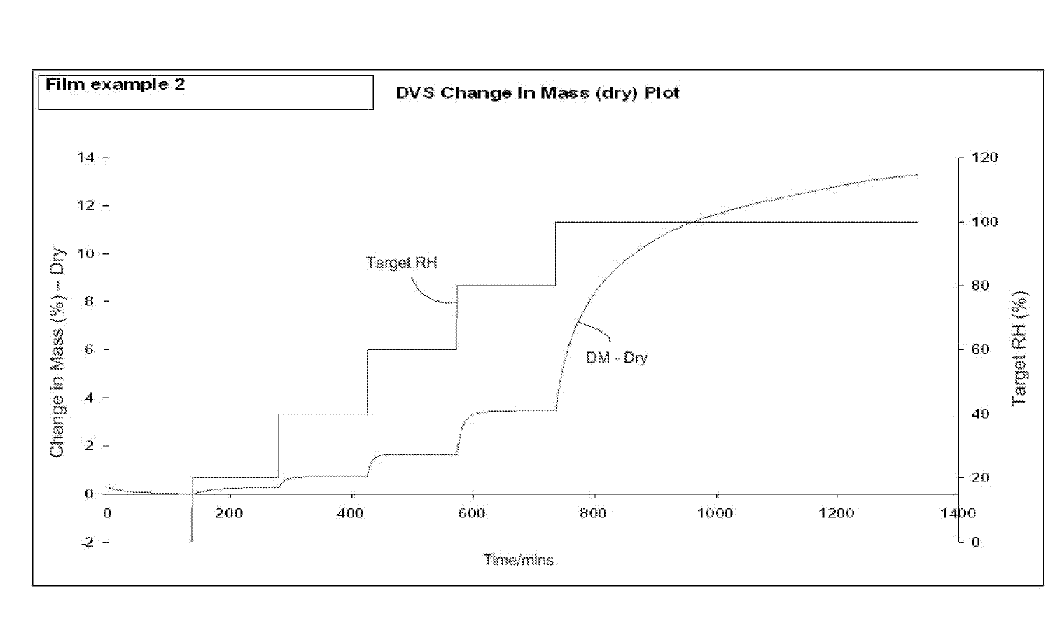

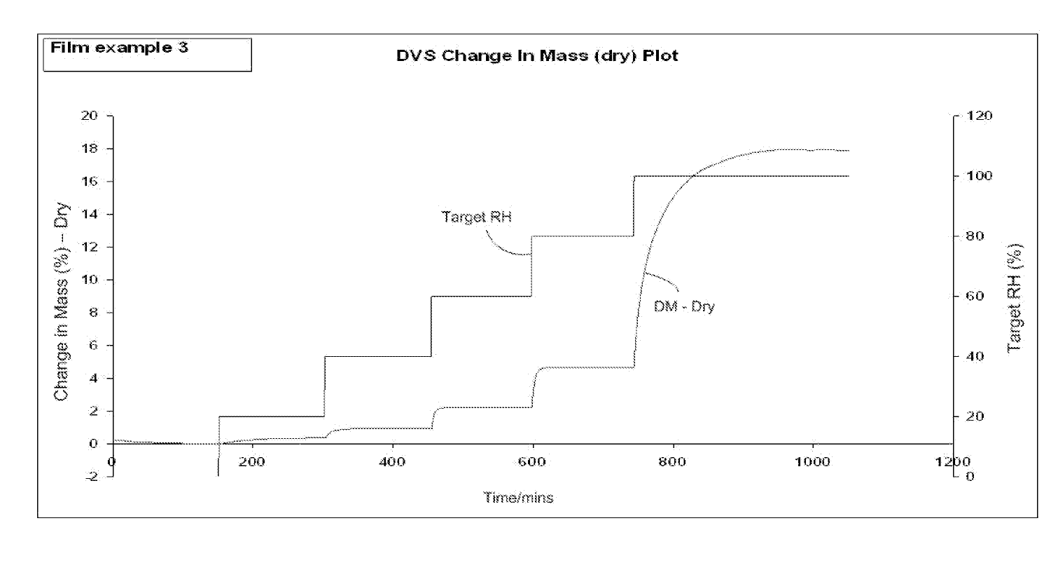

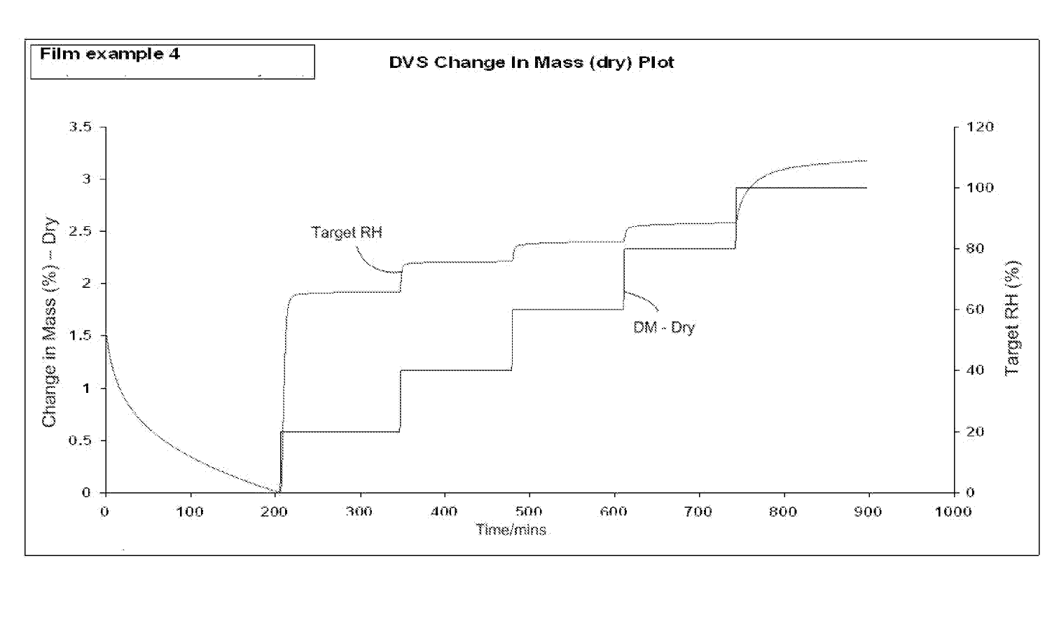

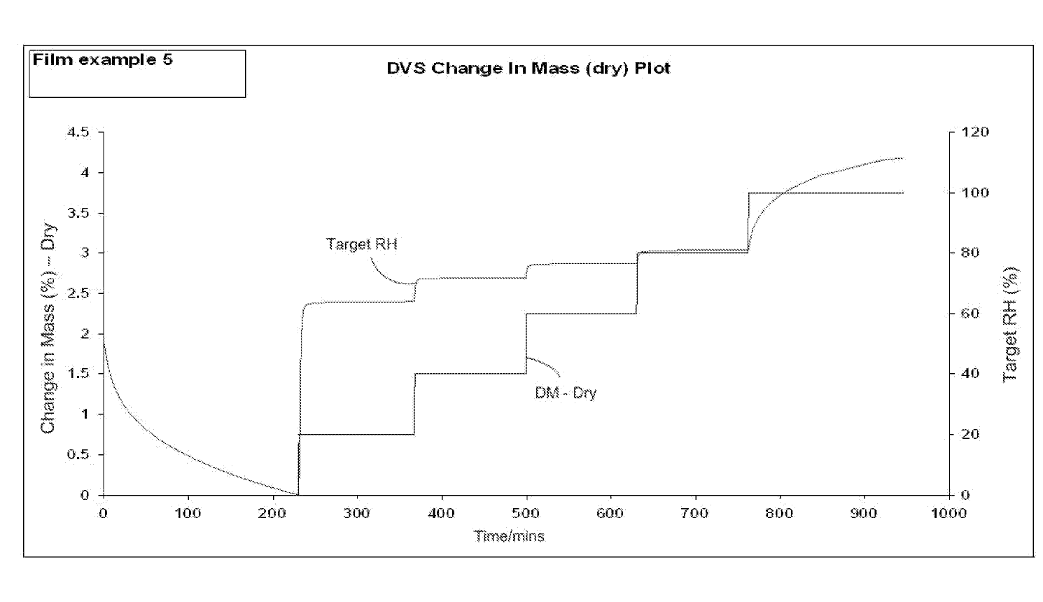

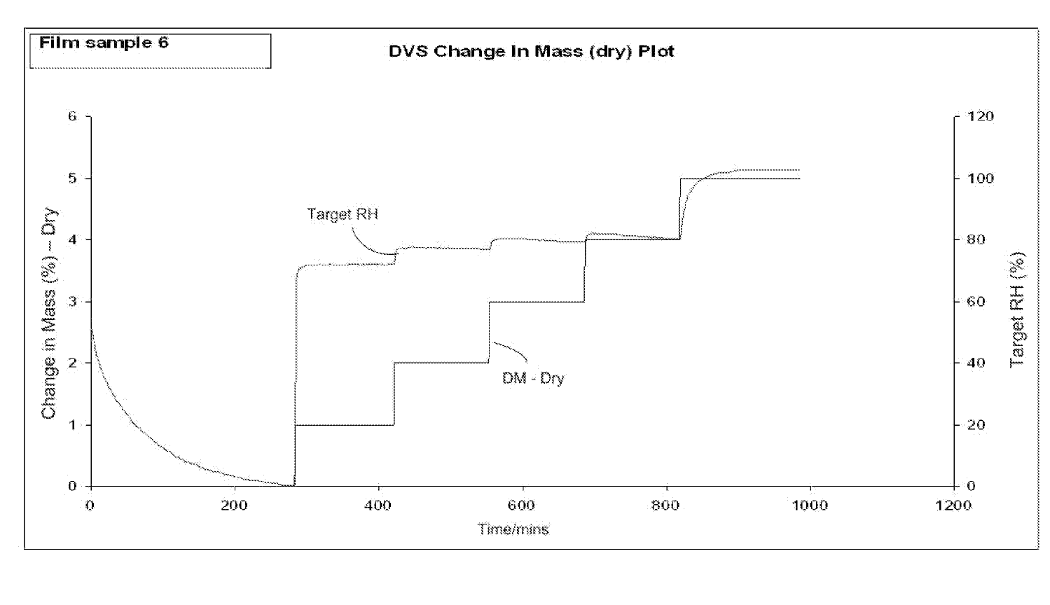

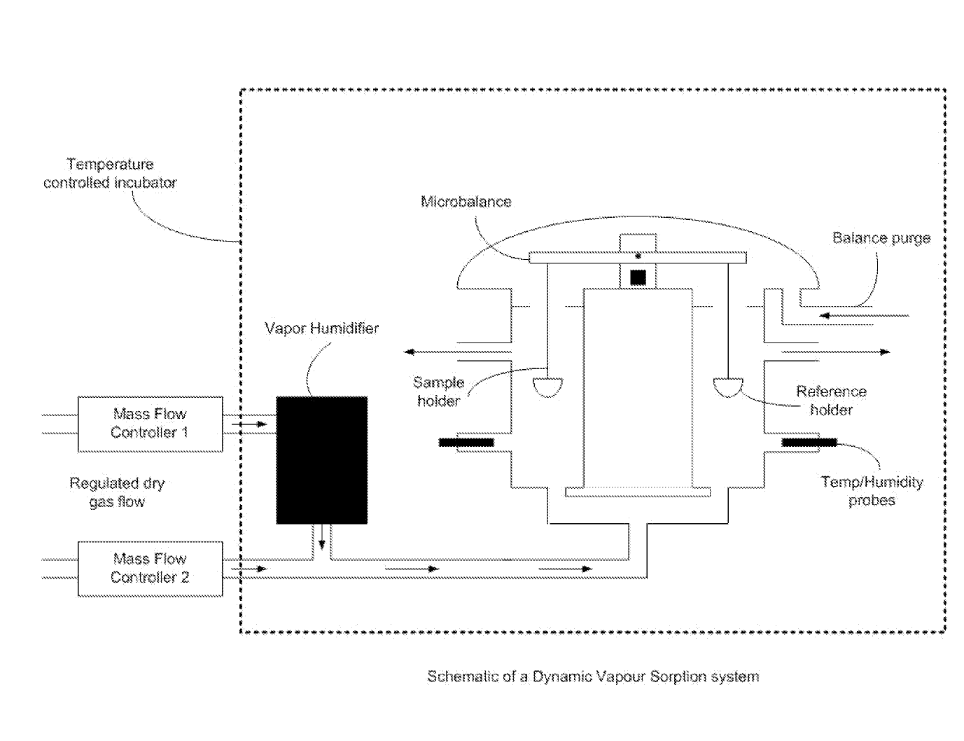

Water uptake kinetics were measured by a Dynamic Vapor Sorption (DVS) analyzer (sorption measurement), see below and FIG. 1.1 for a more detailed description. In essence, with this method the gravimetric change as function of time is followed by exposing the film sample to an atmosphere of which the relative humidity is changed abruptly. The sorption measurements were performed on the films as described in Examples 1-6 at 25° C. The relative humidity (RH) of the atmosphere is changed in steps from 0% RH to 20% RH, 40% RH, 60% RH, 80% RH and 100% RH.

In the graphs labeled with “Film example 1-6” the relative change in weight is presented due to a abrupt change in relative humidity as a function of time. The relative humidity versus time is presented in these graphs as well. In the graphs the film example number is indicated.

From a close inspection of these graphs, it is clear that films that are able to shrink freely during drying (examples 1 and 4) show a relative low water uptake speed, that is the change in weight in reaction to a change in relative humidity is relatively slow. The uptake speed increases for the films prepared under conditions where the films are dried under fixed conditions (Examples 2 and 5). The uptake speed increases even more for those films that have been biaxially stretched as well (Examples 3 and 6). It is clear from these examples that the functional sheets according to the invention have a quick response time to a specific change in its environment, here the change in relative humidity.

### Description of DVS Sorption Analyzer

A DVS sorption analyzer is available from Surface Measurement Systems Ltd. A schematic of a typical Dynamic Vapour Sorption (DSV) system configuration is shown in FIG. 1.1.

At the heart of the DVS system is an ultra-sensitive recording microbalance capable of measuring changes in sample mass lower than 1 part in 10 million. This type of microbalance has very good long term stability and is therefore very well suited to the measurement of vapour sorption phenomena which may take from minutes to days.

The main instrument is housed in a precisely controlled constant temperature incubator. This ensures very high instrument baseline stability as well as accurate control of the relative humidity generation. In the case of the DVS 1000/2000 instruments, the microbalance is housed in a separate temperature zone from the sample region, due to the wide temperature span of the incubator (5-85° C.).

The required humidities are generated by mixing dry and saturated vapour gas flows in the correct proportions using mass flow controllers. Humidity and temperature probes are situated just below the sample and reference holders to give independent verification of system performance. The microbalance mechanism is very sensitive to sorption and desorption of moisture, therefore a constant dry gas purge to the balance head is provided to give the best performance in terms of baseline stability.

The DVS instrument is fully automated under control from a dedicated microcomputer.

### Example 7, 8 and Comparative Experiment 1

For Example 7 and 8 two different sheets of Solupor® were used: Sample 7: Solupor® E9H06A sheet and Sample 8: Solupor® E16P25A sheet (obtained from DSM Solutech B.V.) were impregnated with a mixture of 1 wt. % bromocresol green in ethanol. The impregnation time was 3 minutes; the impregnation was carried out at room temperature. After impregnation, the resultant sheets were washed in water. In the washing step the sheets were immersed in water under shaking conditions for 3 minutes. The washing step was repeated three times. The sheets were dried in a chamber at 40° C. under N₂-flush. The resulting colour of the sheets was yellowish.

As a comparative experiment, bromocresol green was introduced in a PE material using a film melt cast process. Sabic LLDPE grade 318B was applied (Comparative Experiment 1). A powder mixture was prepared containing 0.5 wt. % bromocresol powder and 99.5 wt. % of the LLDPE grade. This powder mixture was introduced in a 30 cm (width of the slid) Collin film cast line. Typical melt temperature was 270° C., chill role temperature 20° C. and line speed 5 m/min. Film thickness was 30 micrometer. The resulting colour of the sheets was yellowish.

The materials of Example 7, 8 and of the Comparative Experiment 1 were exposed to an ammonia vapour. This was performed by exposing the films to the opening of a bottle containing ammonia. The materials of Example 7, 8 were changing colour almost instantaneously. It took less than a second for the colour to change from yellow to intense blue. For the material of Comparative Experiment 1, the change in colour was much more gradual in time. It took about 10 seconds before the first signs of a blue colour appeared and it took approximately 3 minutes before the system reached an intense blue colour.

From these experiments it can be derived that the porous polymeric carriers from Example 7 and 8 react much faster than the comparative material.

1. Functional sheet comprising a porous polymeric carrier having a porosity of at least 60%, preferably at least 80%, more preferably at least 90%, wherein said polymeric carrier comprises one or more functional compounds, which functional compound provides said sheet with at least one function selected from sensing, scavenging and releasing and wherein the polymeric carrier comprises one or more polyolefins and the average pore size of the polymeric carrier is at least 0.11 μm.

2. Functional sheet according to claim 1, wherein said polymeric carrier comprises as the one or more polyolefins ultrahigh molecular weight (UHMW) polyethylene and/or ultrahigh molecular weight polypropylene.

3. Functional sheet according to claim 1, wherein said polymeric carrier is biaxially stretched.

4. Functional sheet according to claim 1, wherein said polymeric carrier is a non-woven.

5. Functional sheet according to claim 1, in the form of a laminate further comprising a barrier layer, which acts as a barrier for liquid water.

6. Functional sheet according to claim 1, wherein at least one of said compounds gives a detectable response, preferably an optically detectable response, to a specific change in its environment.

7. Functional sheet according to claim 1, wherein at least one of said functional compounds has a scavenging function, preferably a water and/or oxygen scavenging function.

8. Functional sheet according to claim 1, wherein one or more of said functional compounds are solved in said carrier.

9. Functional sheet according to claim 1, wherein one or more of said compounds are present in pores of the carrier material.

10. Method for preparing a functional sheet according to claim 1, comprising preparing a porous polymeric carrier and impregnating said porous polymeric carrier with said one or more functional compounds by contacting said porous polymeric carrier with a solution of said one or more functional compounds.

11. Packaging material comprising a functional sheet according to claim 1.

12. Use of a packaging material according to claim 11 for packaging food products, pharmaceuticals, chemicals or electronic products.
